(19) United States
(12) Patent Application Publication
(10) Pub. No.: US 2014/0102622 A1
(43) Pub. Date: Apr. 17, 2014

(54) METHOD AND DEVICE FOR SEALING INSULATING GLASS BLANKS

(71) Applicant: LISEC AUSTRIA GMBH, Seitenstetten (AT)

(72) Inventor: Leopold Mader, Neuhofen/Ybbs (AT)

(21) Appl. No.: 14/122,869

(22) PCT Filed: Jul. 5, 2012
(86) PCT No.: PCT/AT2012/000180

§ 371 Date: Nov. 27, 2013

(30) Foreign Application Priority Data
Sep. 22, 2011 (AT) A 1371/2011

(51) Int. Cl. B32B 7/14

(52) U.S. Cl. CPC B32B 7/14
USPC 156/109; 156/578

(57) ABSTRACT

A hot melt adhesive is introduced as a filling mass from the filling nozzle (13) into the border edges of the insulating glass blanks (3) for filling the edges of the insulating glass blanks (3). The filling mass is guided out from a supply vessel (16) with the help of a barrel pump, to the filling nozzle (14) via pipes (17) and an intermediate storage vessel (15), which compensates pressure fluctuations in the filling mass. When filling the border edges, the insulating glass blank (3) is upright and moves in a reclining manner on the supporting wall (2), on a horizontal conveyor (5) including several conveyor strips (6), which are provided with a coating, to which the filling mass does not adhere. The movements of the insulating glass blank are supported by a driver having at least one suction head which moves synchronously in relation to the horizontal conveyor.

The invention relates to a method and a device for sealing insulating glass blanks during production of insulating glass.

Insulating glass usually consists of at least two glass disks, which are connected to one another at a distance from one another via a spacer. Spacers are placed inward relative to the outside edge of the glass disks so that a border edge that is still open is produced in the insulating glass blank. This border edge is filled when sealing with sealing compound, so that the final composite of the glass disks is achieved.

For sealing insulating glass blanks, different methods and devices have become known that—with one or with two nozzles that move(s) along the edge of the insulating glass blank—fill sealing compound into the border edge that is open outward during the movement thereof along the edge.

The control of the sealing devices is complicated, since not only the size of the border edge, and the relative velocity between sealing nozzle and insulating glass blank, but also the temperature and the type of material used as sealing compound are to be taken into consideration.

The conventional sealing compounds are compounds that harden and predominantly compounds based on polysulfides.

So-called hot-melt adhesives (hot melts), which are in the solid, high-molecular state at room temperature, are also known. By heating, they are put into the liquid aggregate state and are able to wet the surfaces to be bonded. Immediately after cooling, forces can be imparted; a solid bonding is thus achieved. It is advantageous in hot-melt adhesives (hot melts) that they consist of solids up to 100% and do not contain any solvents, so that they do not have any shrinkage. It is also known to add additives that allow a secondary cross-linking to hot-melt adhesives. These secondary-cross-linking hot-melt adhesives, provided with additives, further cross-link under the influence of moisture after falling below the melting point. Hot-melt adhesives based on ethylene-vinyl acetate and based on polyester are known. In addition, hot-melt adhesives based on polyamide and based on silanes are known.

The object of the invention is to indicate a method of the above-mentioned type, in which a hot-melt adhesive, in particular a reactive hot-melt adhesive, can be used as a sealing compound.

This object is achieved according to the invention with a device that has the features of claim 1.

Preferred and advantageous configurations are subjects of the subclaims.

Insofar as the device according to the invention is concerned, the object underlying the invention is achieved with the independent claims aimed at the device.

Preferred and advantageous configurations of the device according to the invention are subjects of the subclaims that are dependent on the device claims.

Since, in the method according to the invention, the sealing compound in the form of hot-melt adhesive is fed via an intermediate storage unit to the sealing nozzle, considerable advantages will emerge.

First, fluctuations when delivering hot-melt adhesive, used as sealing compound, from the barrel by the barrel pump are compensated for, and after the intermediate storage unit, a constant and uniform feeder stream is produced that ensures a uniform filling of the border edge when sealing insulating glass blanks.

The intermediate storage unit also allows an empty barrel to be exchanged for a new (full) barrel without interrupting the sealing, when this is necessary. Thus, the method according to the invention is suitable for bypassing the barrel changeover and even thus ensuring a continuous embodiment of the sealing of insulating glass blanks. In addition, the method according to the invention makes it possible to regulate the amount of sealing compound sprayed into the border edge (hot-melt adhesive—hot melt) at constant temperature solely by the size of the nozzle opening (for example adjusted using a rotary slide) and based on the pressure applied to the sealing compound at the nozzle.

In a preferred embodiment, the intermediate storage unit is designed as a cylinder in which a movable piston that applies compound that is contained in the cylinder (hot-melt adhesive—hot melt) is housed, whereby the piston moves back when there are pressure increases in the sealing compound and is pushed forward when there are pressure reductions, so that at the outlet of the intermediate storage unit and thus on the (at least one) sealing nozzle, a uniform stream of hot-melt adhesive is provided, although sealing compound is delivered intermittently (in pulses) from the barrel pump to the intermediate storage unit.

In a preferred embodiment, the intermediate storage unit is designed to travel with the sealing nozzle and in particular as an extruder pressing unit, so that a spatially advantageous arrangement is produced.

A pressure equalization is achieved by the embodiment according to the invention with an intermediate storage unit (intermediate buffer) designed as a hydraulic cylinder and ensures a continuous production (sealing).

Insofar as the device is concerned, an especially advantageous mode of operation and a simple design are produced when the insulating glass blank abuts a roller field and is supported from below by a conveyor belt, which has a coating to which the hot-melt adhesive, which is used as a sealing compound, does not adhere. For most hot-melt adhesives, in particular those that are secondarily cross-linked, a silicone-coated conveyor element is suitable.

In the conveyor belt that is preferably divided into several sections, one section is provided that can be lowered so that the sealing nozzle, when the lower, horizontal edge of the insulating glass blank must be sealed, can be applied from below on the insulating glass blank. This embodiment makes it possible to operate with a so-called single-nozzle sealing machine that is guided to move back and forth in the machine via a slot on a (machine stand) securely-mounted guide beam.

In a preferred embodiment, the intermediate buffer, which is designed as, for example, a hydraulic cylinder, is mounted on the slots, via which the sealing nozzle and the device parts assigned thereto can be moved back and forth, so that said cylinder is entrained with the sealing nozzle and only short paths are produced between the intermediate buffer and the sealing nozzle.

Additional details and features of the invention will emerge from the description below of a preferred embodiment based on the drawings. Here:

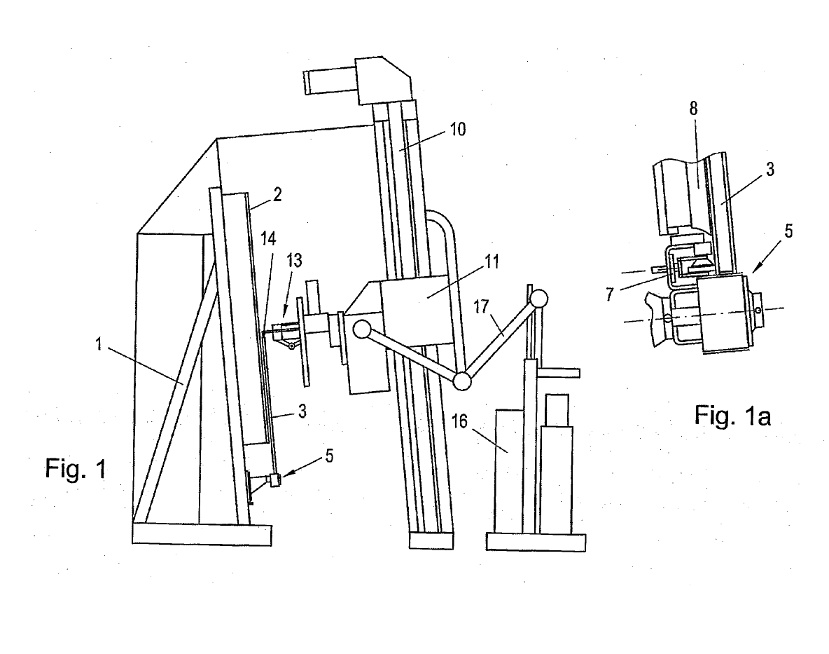

FIG. 1 shows a sealing device in side view,

FIG. 1a shows a detail,

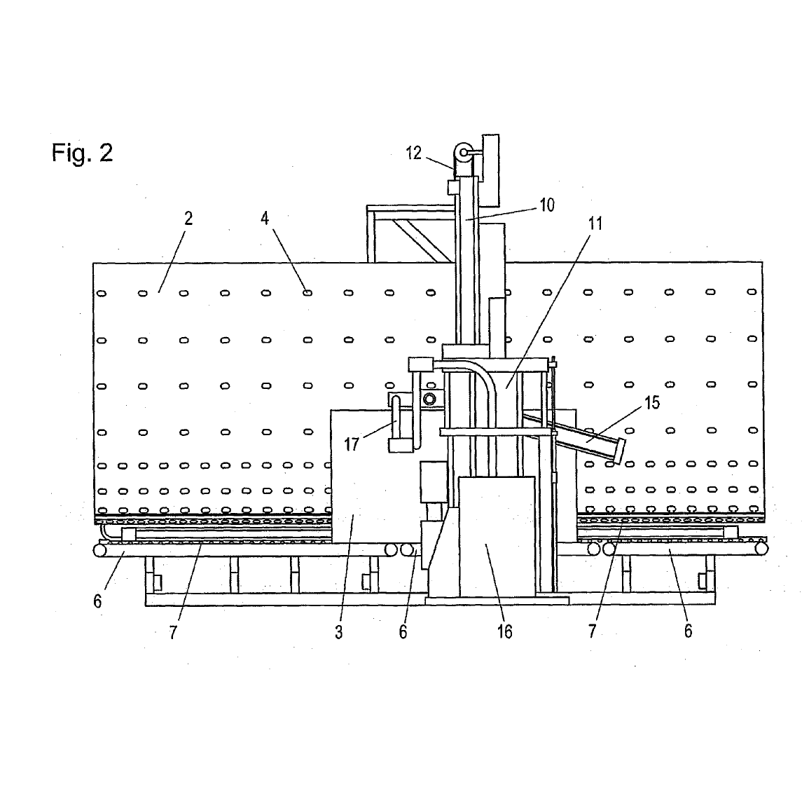

FIG. 2 shows the sealing device from the front,

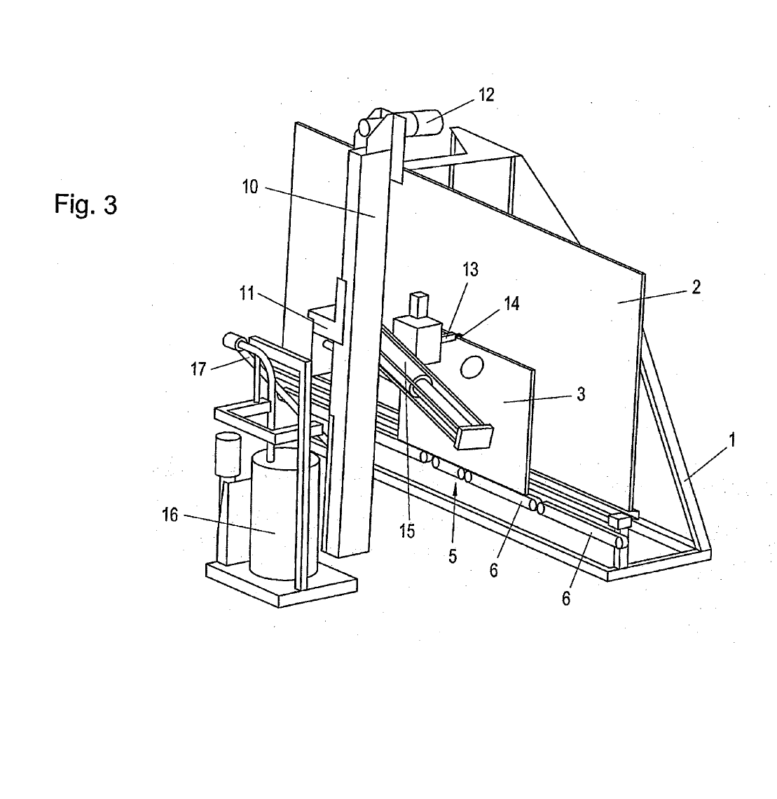

FIG. 3 shows an oblique view of the sealing device,

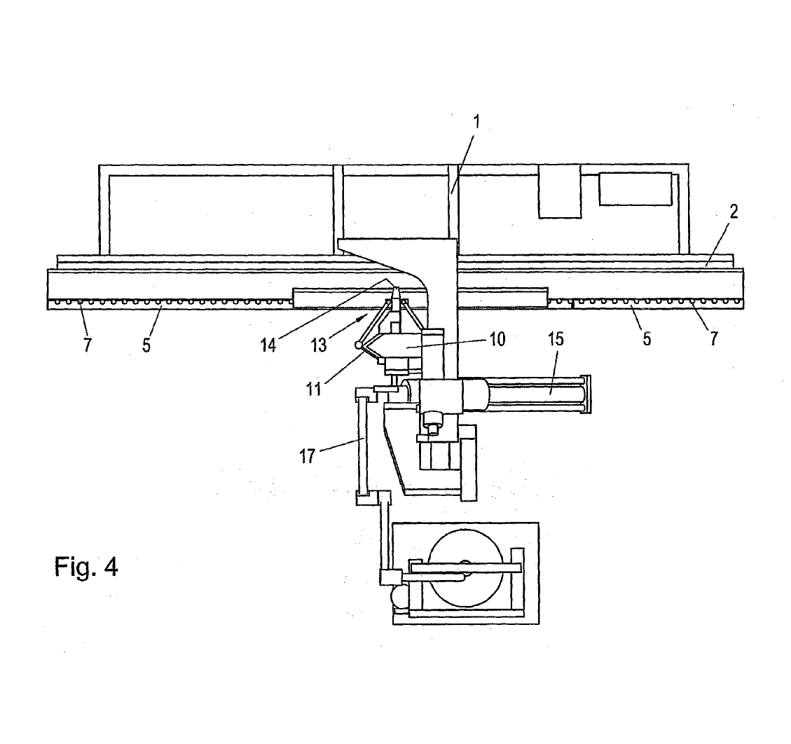

FIG. 4 shows a top view of the sealing device, and

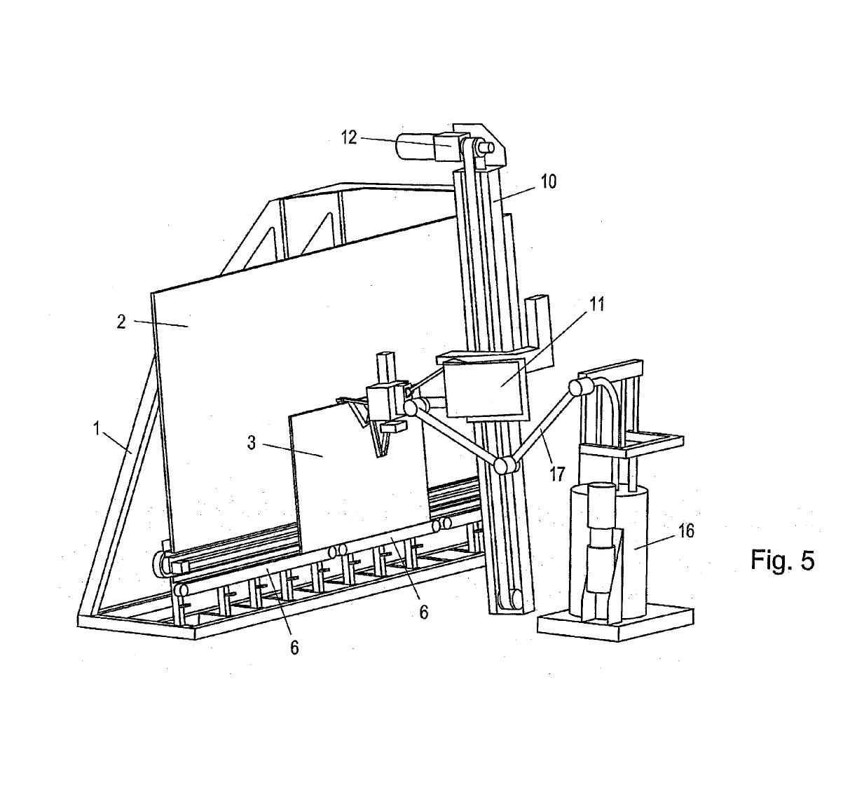

FIG. 5 shows another oblique view of the sealing device.

A sealing device according to the invention has a support field 2, mounted in a machine frame 1 (“machine stand”), for the insulating glass blank 3 that is to be sealed.

In the embodiment that is shown, the support field 2 is designed as a roller field, i.e., comprises a panel (wall), in which several freely rotatable rollers 4 are mounted.

On the lower edge of the support field 2, a horizontal conveyor 5 is provided, which is divided into several endless belt sections 6. The conveyor belt of each of the sections 6 is provided with a coating to which the hot melt (hot-melt adhesive) used in the sealing device as a sealing compound does not adhere. For most hot-melt adhesives, a coating of the conveyor belts that is made of silicone is suitable.

Following in particular from the depiction of FIG. 1a, a series of guide rollers 7 is provided slightly above the horizontal conveyor 5, which ensure the exact course of the insulating glass blank 3 during transport and during sealing of the same.

In addition, as can be seen from FIGS. 1 and 1a, at least one suction conveyor is provided with a suction head 8, which can move parallel to the horizontal conveyor 5 and which takes over the function of the transport of the insulating glass blank 3, while its upper and lower horizontal edge is sealed. This suction device 8 also ensures that the insulating glass blank 3 remains standing in the correct position when the vertical edges of the insulating glass blank 3 are sealed.

As FIG. 1 shows, the support field 2, as is common for vertical units, inclines rearward by several degrees, for example 5 degrees.

A guide beam 10, on which a slot 11 is guided to move back and forth using a drive 12, is permanently mounted at a distance from the support field 2. The slot 11 carries a sealing head 13 with a sealing nozzle 14 and an intermediate buffer 15 that is designed as a hydraulic cylinder for the sealing compound that is used.

The sealing compound is fed to the intermediate buffer 15 from a barrel 16, in which sealing compound (hot-melt adhesive) is contained, using a barrel pump via lines 17. In addition, since a hot-melt adhesive is involved, a heater is assigned to the barrel 16 to heat the hot-melt adhesives to the processing temperature.

In the embodiment that is shown, the sealing device is designed as a single-nozzle sealing device, so that a single nozzle 14 is provided that travels the periphery of the insulating glass blank 3 during sealing. To this end, the insulating glass blank 3 is supported by the conveyor system 5 when the upper and lower horizontal section of the border edge is being sealed, and at least one suction conveyor moves horizontally through the suction head 8, whereby the sealing nozzle 14 stands still. When sealing the two vertical edges, the insulating glass disk blank 3 stands still, and the sealing nozzle 14 is moved back and forth over its slots 11 in order to fill the vertical edges with sealing compound (hot melt).

It is understood that as is common for sealing units, the sealing nozzle 14 is arranged to pivot on the sealing head 13, so that it can occupy the correct position in each case relative to the border edge. In this case, infinitely variable rotatability can also be provided when an insulating glass blank 3 with a special shape is to be sealed.

The intermediate buffer 15 is designed as a hydraulic cylinder, as can be seen from the drawings, whereby in the cylinder whose piston in the cylinder is housed in such a way as to be able to move, a space is provided that is loaded via the line 17 from the barrel pump with hot-melt adhesive from the barrel 16. The piston of the intermediate buffer 15 is loaded hydraulically (it is preferably loaded elastically) and thus is able to compensate for (periodic) pressure changes, which are produced by the activity of the barrel pump, so that sealing compound (hot-melt adhesive) is fed without pressure fluctuations from the intermediate buffer 15 to the sealing nozzle 14.

The intermediate storage unit 15 also makes it possible to load the sealing nozzle 14 with sealing compound while a barrel 16 is being changed.

Thus, not only is uniform operation with constant (but adjustable) pressure produced, but also continuous operation, since the sealing does not need to be interrupted when a barrel is being changed.

1. Method for filling the border edge of insulating glass blanks during production of insulating glass, in which a filling compound is introduced into the border edge that is open outward, characterized in that a compound based on a hot-melt adhesive is used as a filling compound.

2. Method according to claim 1, wherein a hot-melt adhesive based on ethylene-vinyl acetate, polyester, polyamide or silanes is used as a hot-melt adhesive.

3. Method according to claim 1, wherein the hot-melt adhesive is fed to the nozzle from which hot-melt adhesive is introduced as a filling compound into the border edge, via an intermediate storage unit.

4. Method according to claim 3, wherein the hot-melt adhesive is loaded elastically with pressure in the intermediate storage unit.

5. Method according to claim 3, wherein the hot-melt adhesive is loaded with pressure in the intermediate storage unit via a piston that can move in the intermediate storage unit.

6. Method according to claim 1, wherein the insulating glass blank is processed essentially standing vertically.

7. Method according to claim 6, wherein the insulating glass blank is processed on a conveying means or upright.

8. Method according to claim 6, wherein the insulating glass blank is processed upright on a conveyor belt or a series of conveyor belts.

9. Method according to claim 7, wherein a conveying means, in particular a conveyor belt, is used, which has anti-adhesive properties relative to the hot-melt adhesive that is used.

10. Method according to claim 9, wherein a conveying means, in particular a conveyor belt, is used, which is provided with a coating, in particular a silicone-based coating, that has anti-adhesive properties relative to the hot-melt adhesive that is used.

11. Method according to claim 1, wherein the amount of hot-melt adhesive that is introduced in the border edge of the insulating glass blank at constant temperature of the hot-melt adhesive is adjusted by changing the free outlet cross-section of the nozzle, from which hot-melt adhesive is released into the border edge.

12. Method according to claim 11, wherein the amount of hot-melt adhesive introduced in the border edge is adjusted in addition by changing the pressure with which the hot-melt adhesive is loaded in the intermediate storage unit.

13. Device for implementing the method according to claim 1, characterized by
A support field (2) on which adjacent, essentially vertical insulating glass blanks (3) are held or moved,
A conveying system (5) in the area of the lower edge of the support field,
At least one sealing head (13), which is arranged opposite to the support field (2), which has a filling nozzle (14), and which can move back and forth on an essentially vertical guide beam (11),
A storage container (16) with a heating system for hot-melt adhesive,
A connecting line (17) for hot-melt adhesive between the storage container (16) and the sealing head (13), and
At least one intermediate storage unit (15) for hot-melt adhesive in the connecting line (17).

14. Device according to claim 13, wherein the conveying system (5) comprises at least one conveyor belt.

15. Device according to claim 14, wherein the conveyor belt (6) is provided with an anti-adhesive coating.

16. Device according to claim 15, wherein the coating is a coating based on silicone.

17. Device according to claim 13, wherein the intermediate storage unit (15) is arranged to travel with the sealing head (13).

18. Device according to claim 13, wherein the intermediate storage unit (15) is a cylinder, in which a piston is housed in a movable manner, and wherein the piston is loaded elastically with pressure medium.

19. Device according to claim 13, wherein a pump, preferably a barrel pump, is assigned to the storage container (16) for conveying hot-melt adhesive to the sealing head (14) or to the intermediate storage unit (15).

20. Device according to claim 13, wherein the conveying system (5) comprises at least one carrier (8) that grasps one of the glass disks of the insulating glass blank (3) and that is driven synchronously with the horizontal conveyor (5).

21. Device according to claim 20, wherein the carrier is at least one suction head (8) that can be loaded with underpressure and that can move on a guide that is oriented parallel to the horizontal conveyor (5).

22. Device according to claim 13, wherein the support field (2) is oriented inclined to the vertical by an acute angle, preferably by approximately 5°.

23. Device according to claim 13, wherein the support field (2) is equipped with rollers (4), on which the insulating glass blank (3) rests.

24. Device according to claim 13, wherein the guide beam (10) for the sealing head (14) is oriented parallel to the support field (2).

25. Device according to claim 13, wherein the filling nozzle (14) on the sealing head (13) is mounted to rotate around an axis that is perpendicular to the support field (2).
